(19) United States
(12) Patent Application Publication
(10) Pub. No.: US 2015/0196066 A1
(43) Pub. Date: Jul. 16, 2015

(54) GARMENT HAVING ANTIBACTERIAL, ANTIMICROBIAL, SKIN ENHANCEMENT, SKIN REGENERATION, AND/OR SKIN WELLNESS PROPERTIES AND UTILITY FUNCTIONAL COMPARTMENTS

(71) Applicants: BERT EMANUEL, MISSOURI CITY, TX (US); DIEU RICK QUANG NGO, HOUSTON, TX (US); BAO-QUOC H. LA, HOUSTON, TX (US)

(72) Inventors: BERT EMANUEL, MISSOURI CITY, TX (US); DIEU RICK QUANG NGO, HOUSTON, TX (US); BAO-QUOC H. LA, HOUSTON, TX (US)

(21) Appl. No.: 14/596,203

(22) Filed: Jan. 13, 2015

Related U.S. Application Data
(60) Provisional application No. 61/926,949, filed on Jan. 13, 2014.

(51) Int. Cl. A41D 1/00; A01N 59/20; A41D 31/00; A01N 25/08

(52) U.S. Cl. CPC A41D 1/00; A01N 25/08; A01N 59/20; A41D 31/0077

(57) ABSTRACT

An article of clothing or garment having antibacterial, antimicrobial, skin wellness, skin regeneration, and skin enhancement properties and utility functional compartments is disclosed. The article of clothing may also have antifungal and antiyeast properties. The article of clothing includes a top or shirt component and/or a bottom or pant component wherein at least one of the shirt and pant components may include a metallic component, such as copper, which may provide antibacterial, antimicrobial, antifungal, antiyeast, skin wellness, skin regeneration, and/or skin enhancement properties.

### CROSS-REFERENCE TO RELATED APPLICATION

The present application claims the priority benefit of U.S. Provisional Patent Application Ser. No. 61/926,949, filed Jan. 13, 2014, which is incorporated herein by reference in its entirety.

### BACKGROUND OF THE INVENTION

1. Field of the Invention

The present invention generally relates to garments and articles of clothing. More specifically, the present invention is directed to a garment or article of clothing having antibacterial, antimicrobial, skin enhancement, skin regeneration, and/or skin wellness properties and utility functional compartments. The garment may also have antifungal and antiyeast properties.

2. Description of the Related Art

Garments and articles of clothing having antibacterial, antimicrobial, antifungal and antiyeast properties are known in the art. Also, garments and articles of clothing having utility functional compartments are known in the art.

The present invention overcomes one or more of the shortcomings of the prior art by providing the combination of antibacterial, antimicrobial, skin enhancement, skin regeneration, and/or skin wellness properties and utility functional compartments. The Applicant is unaware of inventions or patents, taken either singly or in combination, which are seen to describe the present invention as claimed.

### SUMMARY OF THE INVENTION

The present invention is directed to a garment or article of clothing having antibacterial, antimicrobial, skin enhancement, skin regeneration, and/or skin wellness properties and utility functional compartments. The garment may also have antifungal and antiyeast properties.

The garment includes a top or shirt component and a bottom or pant component.

As a non-limiting example, the top component has a front side, a rear side, right and left sleeves, a neck opening, an effective amount of an antimicrobial agent, an identification (I.D.) ring that may be made of a copper metal and/or some other metal(s) that could provide additional antibacterial, antimicrobial, antifungal, antiyeast, skin wellness, skin enhancement, and/or skin regeneration properties, a pen pocket, and a gusset in each of the armpit areas. The top component may also have at least one pocket on the front side, at least one pocket on the rear side, and at least one sleeve pocket on 1 or both of the sleeves. Further, the top component may have an effective amount of an antibacterial agent, an effective amount of an antifungal agent, and/or an effective amount of an antiyeast agent.

The neck opening of the top component may have a V-shape, a regular or round shape, or any other shape known to one of ordinary skill in the art.

The antimicrobial agent preferably provides the top component with antibacterial, antimicrobial, antifungal, antiyeast, skin enhancement, skin regeneration, and/or skin wellness properties, and is preferably dispersed or positioned throughout, within, above or below the fabric of the top component.

The identification (I.D.) ring is for the attachment of an I.D. badge. Also, the I.D. ring may be positioned at any predetermined location, such as, but not limited to, one side of the chest area, on the front side of the top component. The identification (I.D.) ring may be made of a copper metal and/or some other metal(s) that could provide additional antibacterial, antimicrobial, antifungal, antiyeast, skin enhancement, skin regeneration, and/or skin wellness properties.

The pen pocket is for holding or retaining writing instrument(s), such as a pen, at the front side. Also, the pen pocket may be positioned at any predetermined location, such as, but not limited to, the other side of the chest area, on the front side of the top component.

The gusset in each of the armpit areas helps to eliminate or reduce chaffing in the armpit areas.

The pocket or pockets at the front side of the top component is for storing or retaining business cards, money, coins, a cellular phone, and/or any other item that may fit within or in that pocket.

The sleeve pocket or pockets is for storing or retaining business cards, money, coins, a cellular phone, and/or any other item that may fit within or in that pocket.

Each of the antibacterial, antimicrobial, antifungal and antiyeast agents provides the top component with self decontaminating properties, respectively, and is preferably dispersed or positioned throughout, within, above or below the fabric of the top component.

As a non-limiting example, the bottom component has a front side, a rear side, an effective amount of an antimicrobial agent, an identification (I.D.) and key ring that may be made of a copper metal and/or some other metal(s) that could provide additional antibacterial, antimicrobial, antifungal, antiyeast, skin wellness, skin enhancement, and/or skin regeneration properties, a cell phone pocket, a cargo pocket, a gusset in the crotch area, a fly opening item, and a bottom component securing means. The bottom component may also have at least one pocket on the rear side. Further, the bottom component may have an effective amount of an antibacterial agent, an effective amount of an antifungal agent, and/or an effective amount of an antiyeast agent.

The antimicrobial agent preferably provides the bottom component with antibacterial, antimicrobial, antifungal, antiyeast, skin enhancement, skin regeneration, and/or skin wellness properties, and is preferably dispersed or positioned throughout, within, above or below the fabric of the bottom component.

The identification (I.D.) and key ring that may be made of a copper metal and/or some other metal(s) that could provide additional antibacterial, antimicrobial, antifungal, antiyeast, skin wellness, skin enhancement, and/or skin regeneration properties, is for the attachment of an I.D. badge and/or keys. Also, the I.D. and key ring may be positioned at any predetermined location, such as, but not limited to, about the waist area of one side of the lower body area, on the front side of the bottom component.

The cell phone pocket is for holding or retaining a cellular phone at the front side. Also, the cell phone pocket may be positioned at any predetermined location, such as, but not limited to, a first thigh area or a first side about the waist area, on the front side of the bottom component.

The cargo pocket is for holding or retaining business cards, a wallet, money, coins, a cellular phone, and/or any other item that may fit within or in that pocket. Also, the cargo pocket may be positioned at any predetermined location, such as, but not limited to, a second thigh area, on the front side of the bottom component.

The gusset in the crotch area helps to eliminate or reduce chaffing in the crotch area and on the inside thigh area.

The fly opening item is positioned about the crotch area on the front side of the bottom component.

The bottom component securing means allows the wearer to secure the bottom component to the wearer's lower body.

The pocket, or each of the pockets, on the rear side of the bottom component is for storing or retaining business cards, money, coins, a cellular phone, and/or any other item that may fit within or in that pocket.

Each of the antibacterial, antimicrobial, antifungal and antiyeast agents provides the bottom component with self decontaminating properties, respectively, and is preferably dispersed or positioned throughout, within, above or below the fabric of the bottom component.

The fabric of the top and bottom components may be any natural, man-made, or a combination of natural and man-made fabric known to one of ordinary skill in the art.

### BRIEF DESCRIPTION OF THE DRAWINGS

FIG. 1 is a front, elevational, environmental view of a garment or article of clothing according to the present invention, showing a top or shirt component and a bottom or pant component;

FIG. 2 is a rear, elevational, environmental view of the garment of FIG. 1;

FIG. 3A is a front view of an embodiment of the top component of the garment according to the present invention;

FIG. 3B is a front view of another embodiment of the top component of the garment according to the present invention;

FIG. 3C is a front view of a further embodiment of the top component of the garment according to the present invention;

FIG. 3D is a front view of a further embodiment of the top component of the garment according to the present invention;

FIG. 3E is a front view of a further embodiment of the top component of the garment according to the present invention;

FIG. 3F is a front view of a further embodiment of the top component of the garment according to the present invention;

FIG. 4A is a rear view of an embodiment of the top component of the garment according to the present invention, showing a right sleeve in a first position and a left sleeve in a second position;

FIG. 4B is a rear view of an embodiment of the top component of the garment according to the present invention, showing the left sleeve in a first position and the right sleeve in a second position;

FIG. 5A is a front view of an embodiment of the bottom component of the garment according to the present invention;

FIG. 5B is a front view of another embodiment of the bottom component of the garment according to the present invention;

FIG. 5C is a front view of a further embodiment of the bottom component of the garment according to the present invention;

FIG. 5D is a front view of a further embodiment of the bottom component of the garment according to the present invention; and

FIG. 6 is a rear view of an embodiment of the bottom component of the garment according to the present invention.

It should be understood that the above-attached figures are not intended to limit the scope of the present invention in any way.

### DETAILED DESCRIPTION OF THE PREFERRED EMBODIMENTS

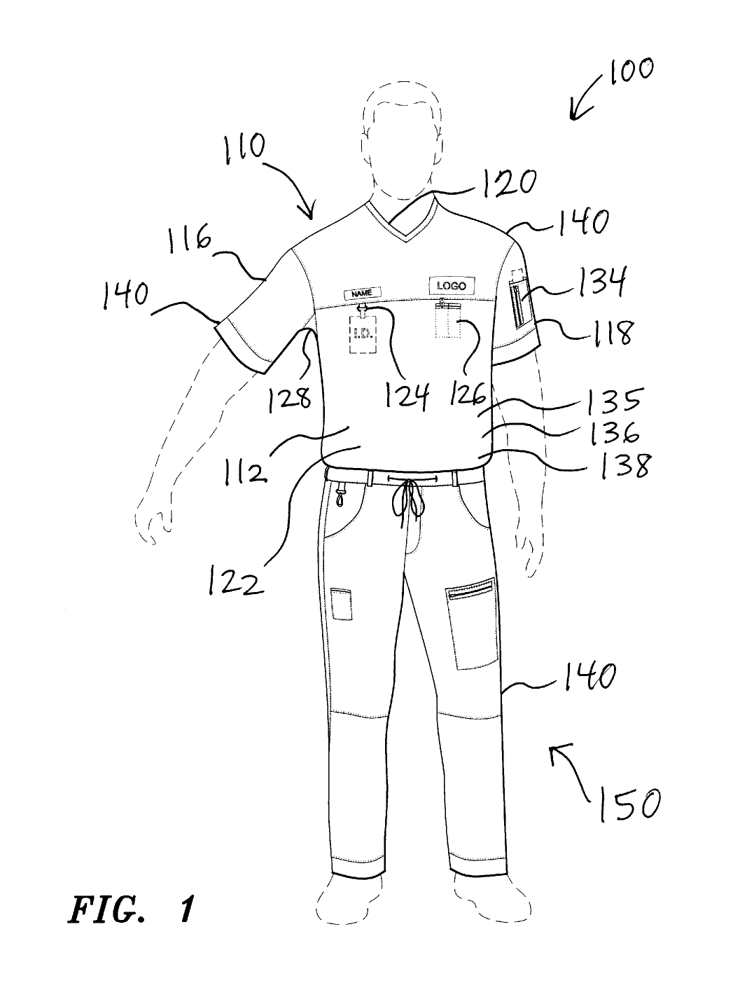

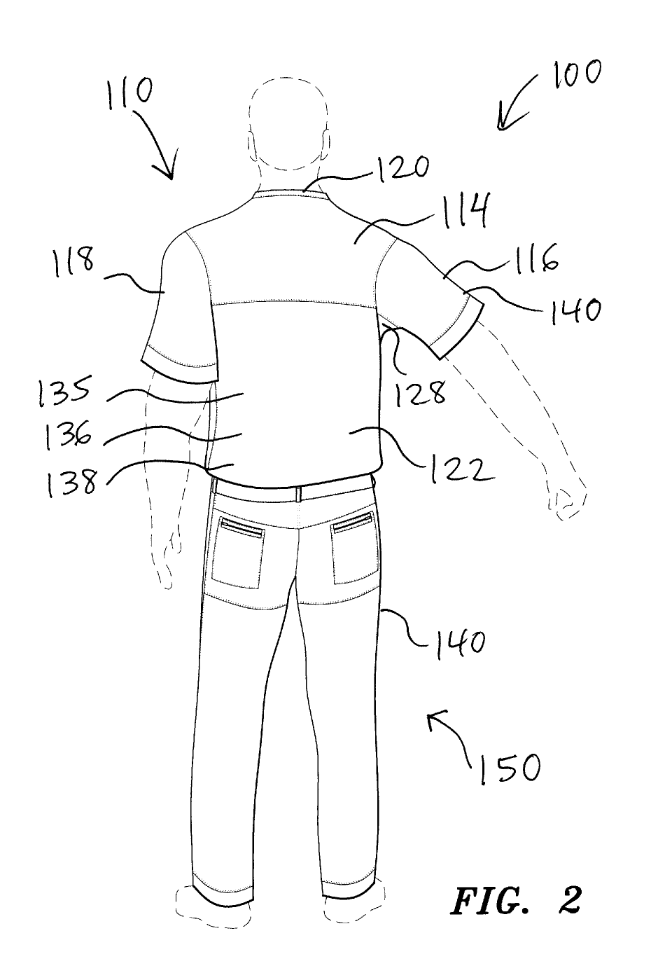

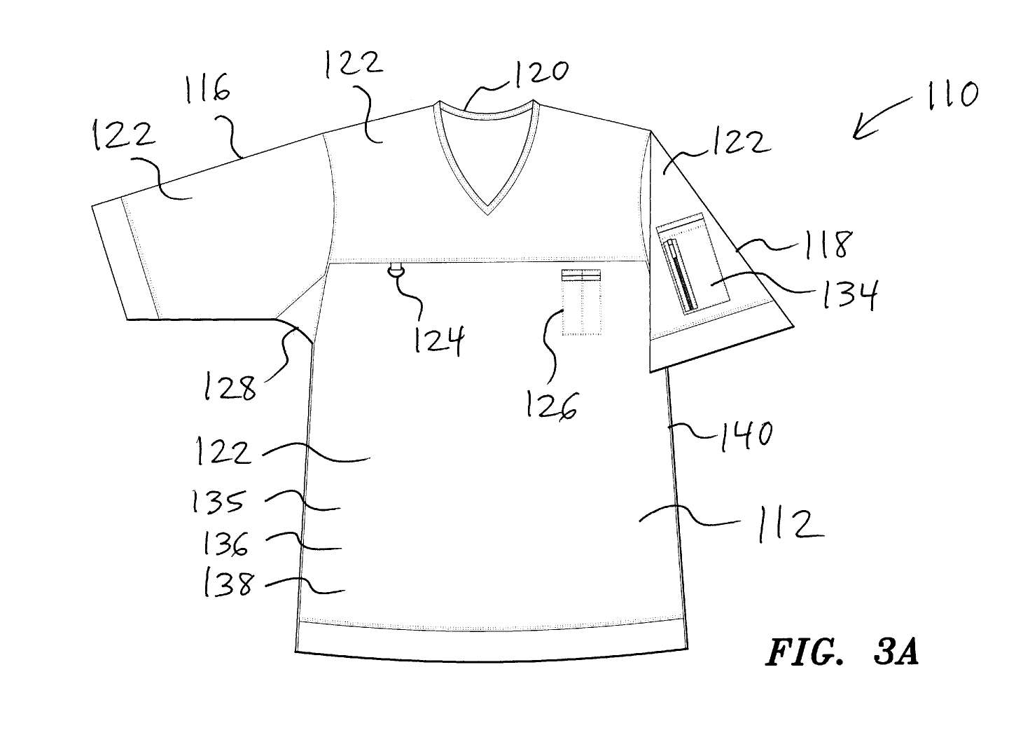

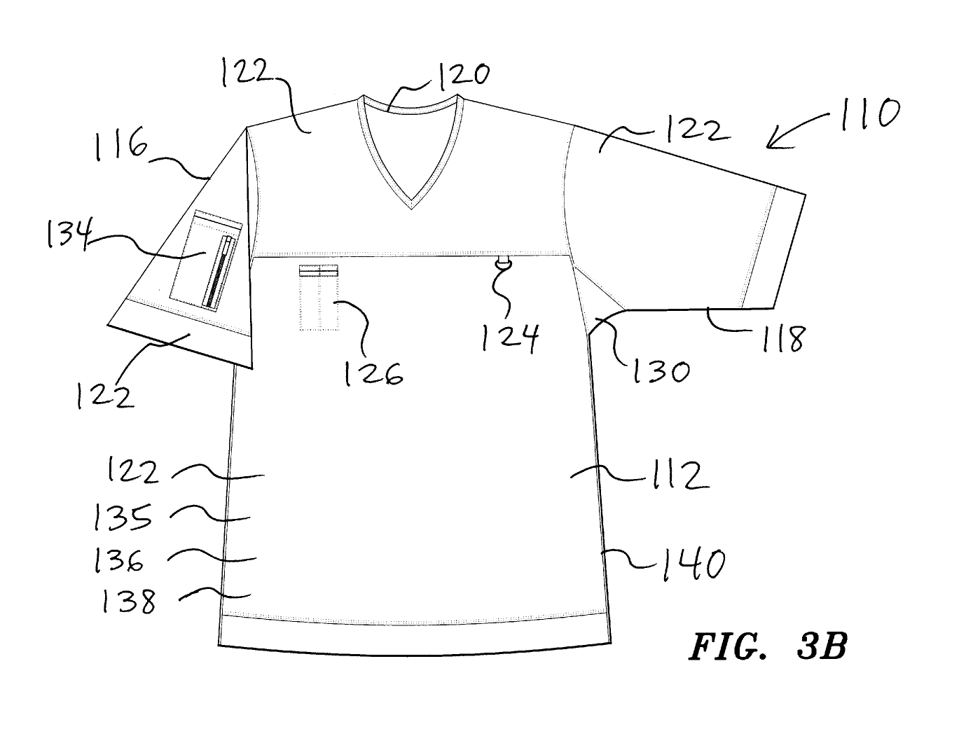

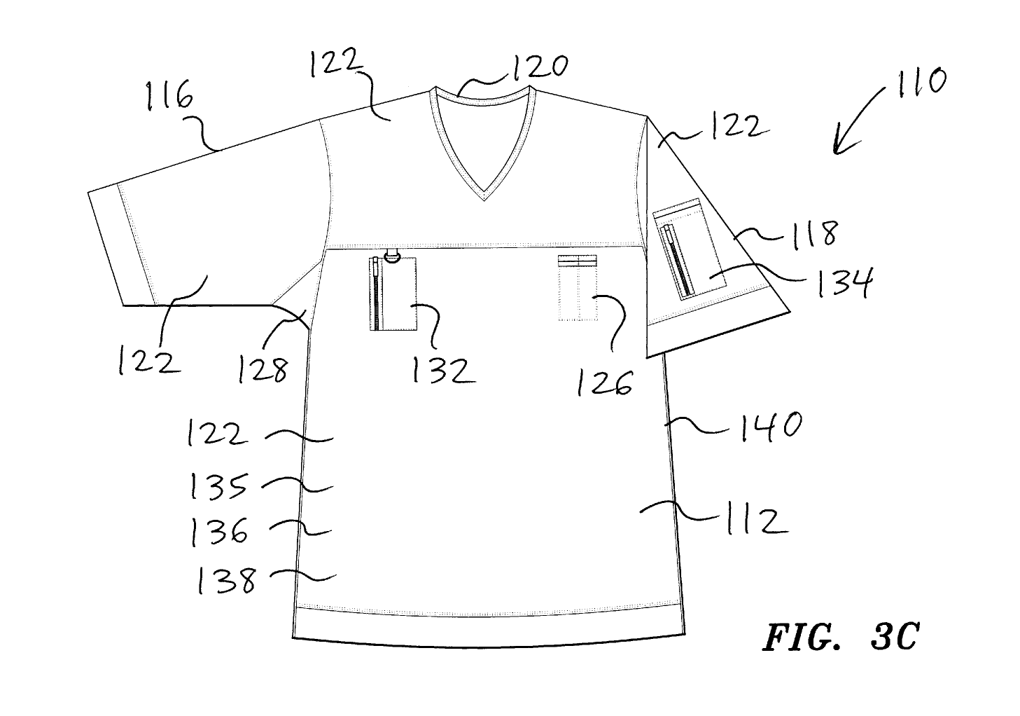

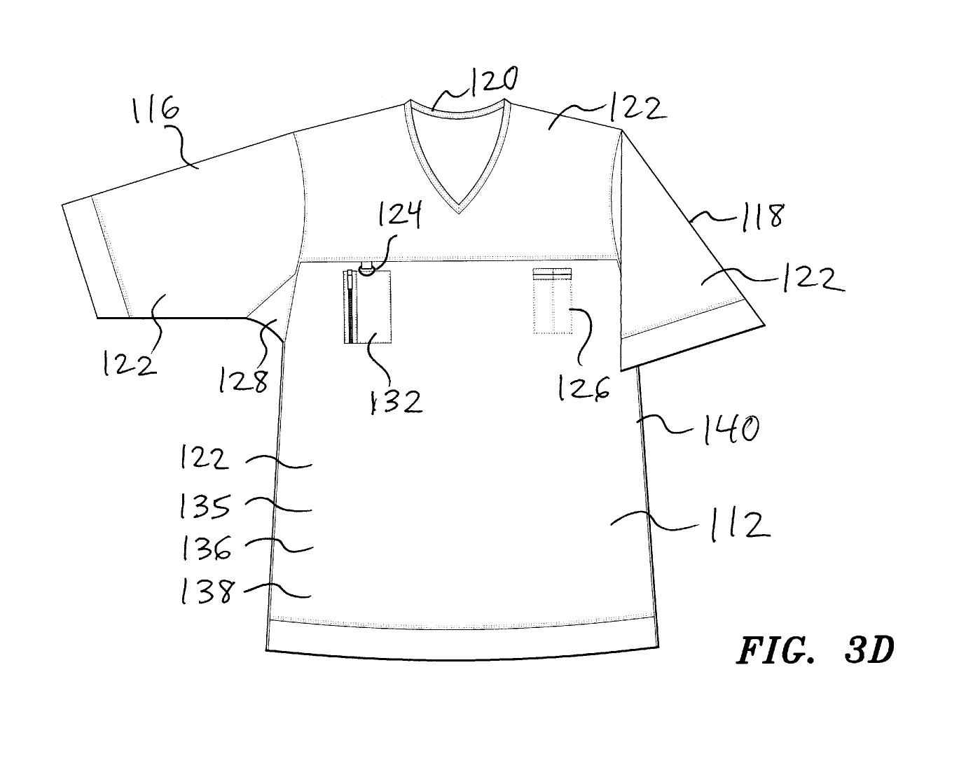

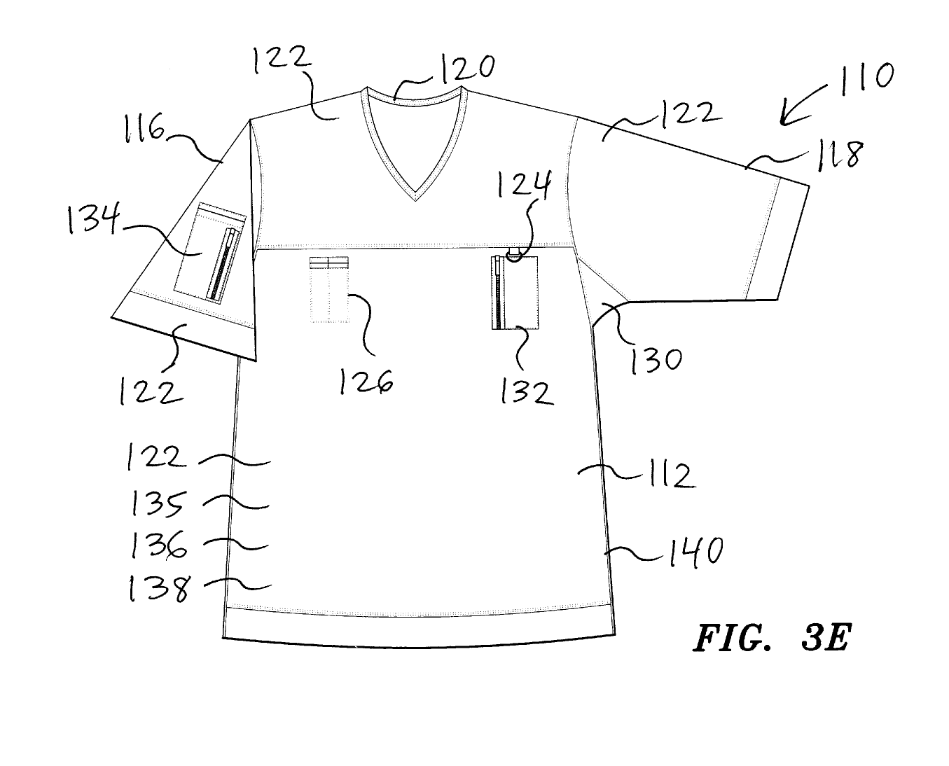

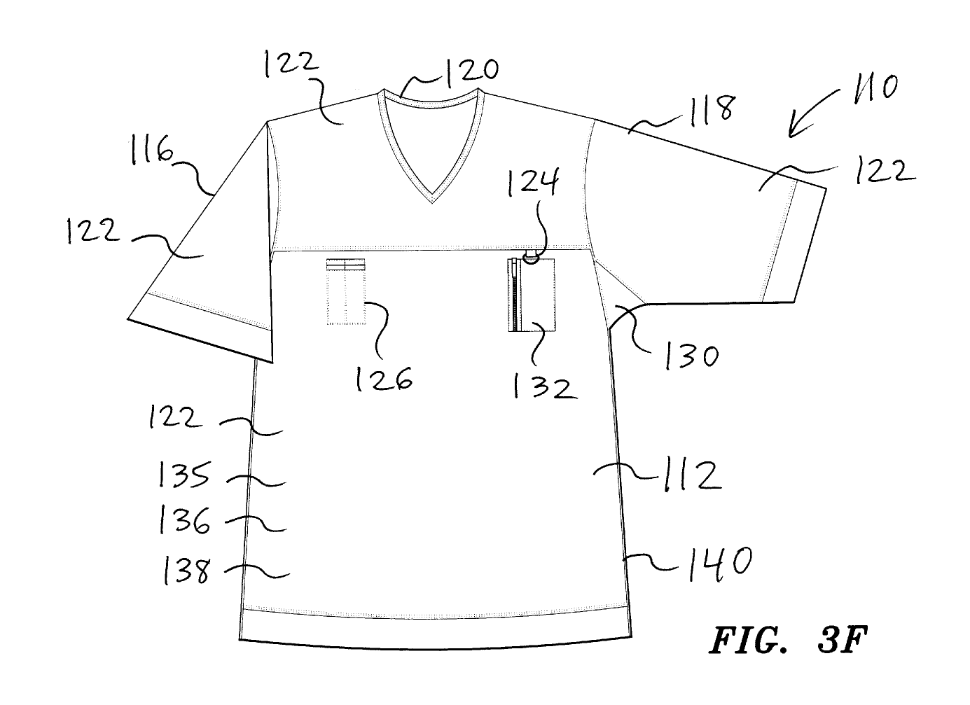

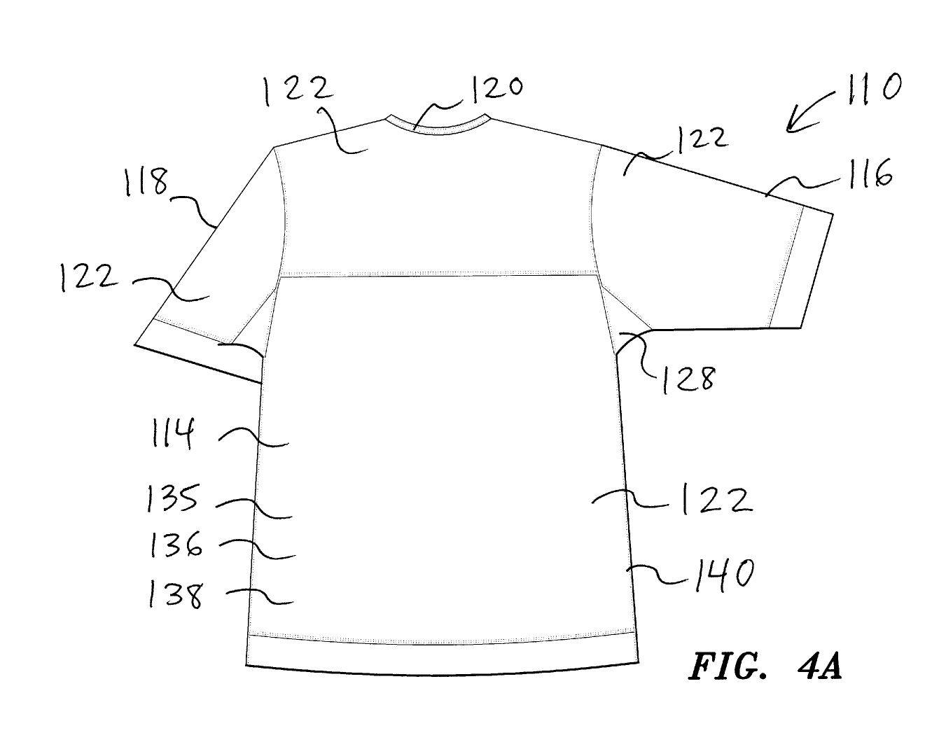

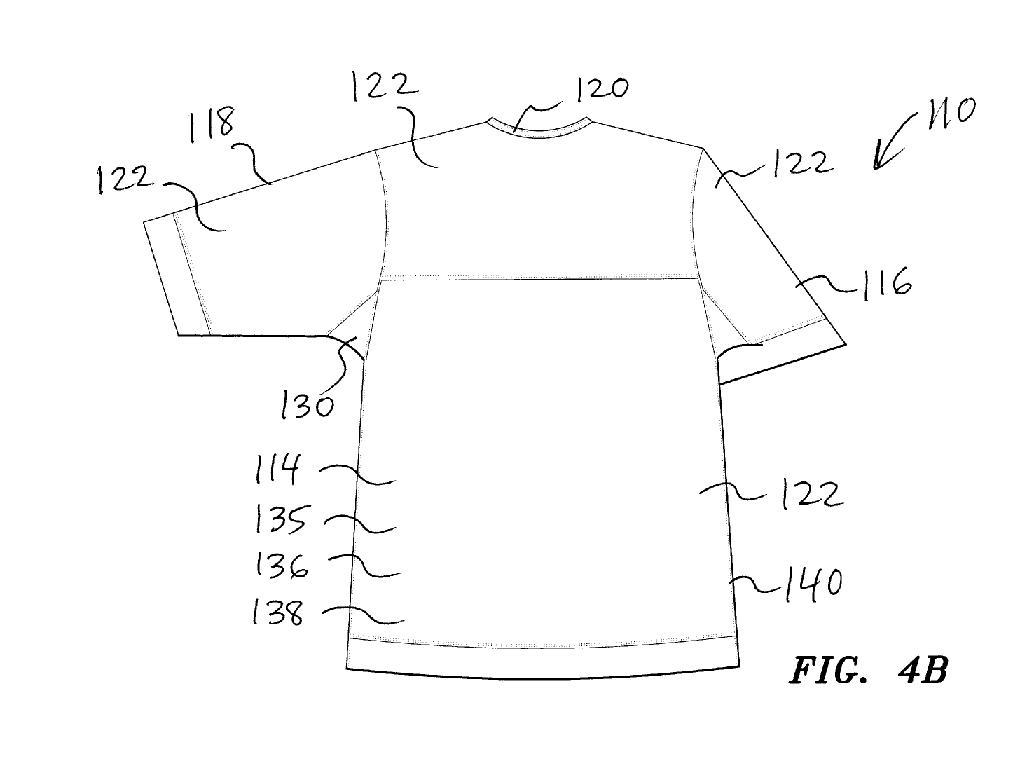

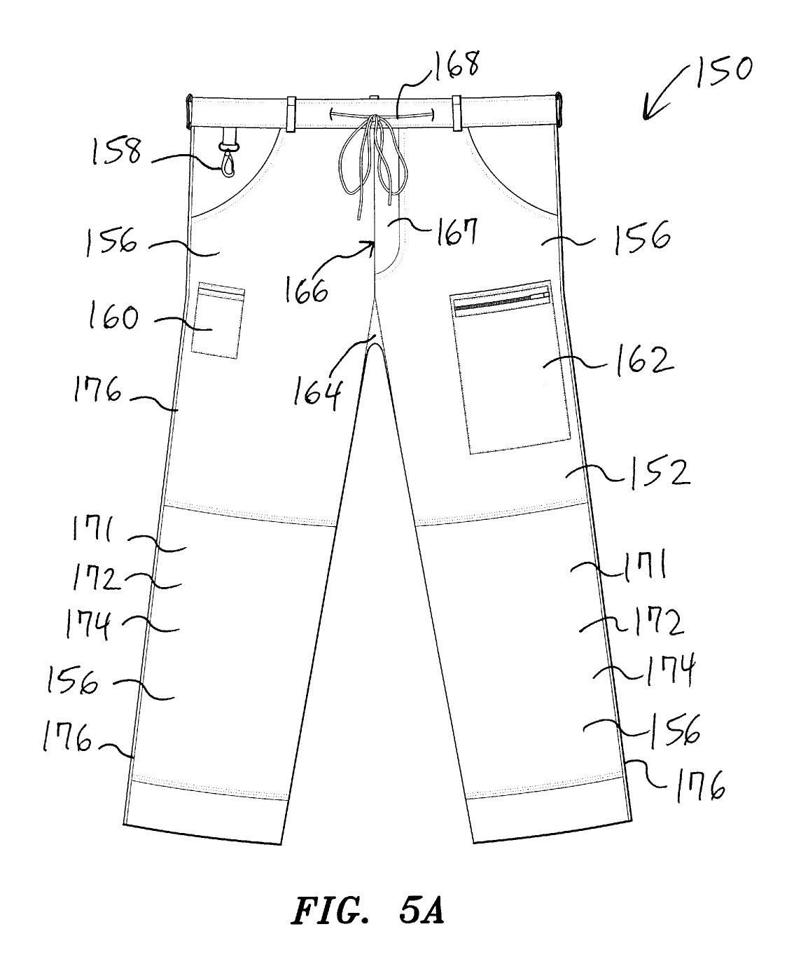

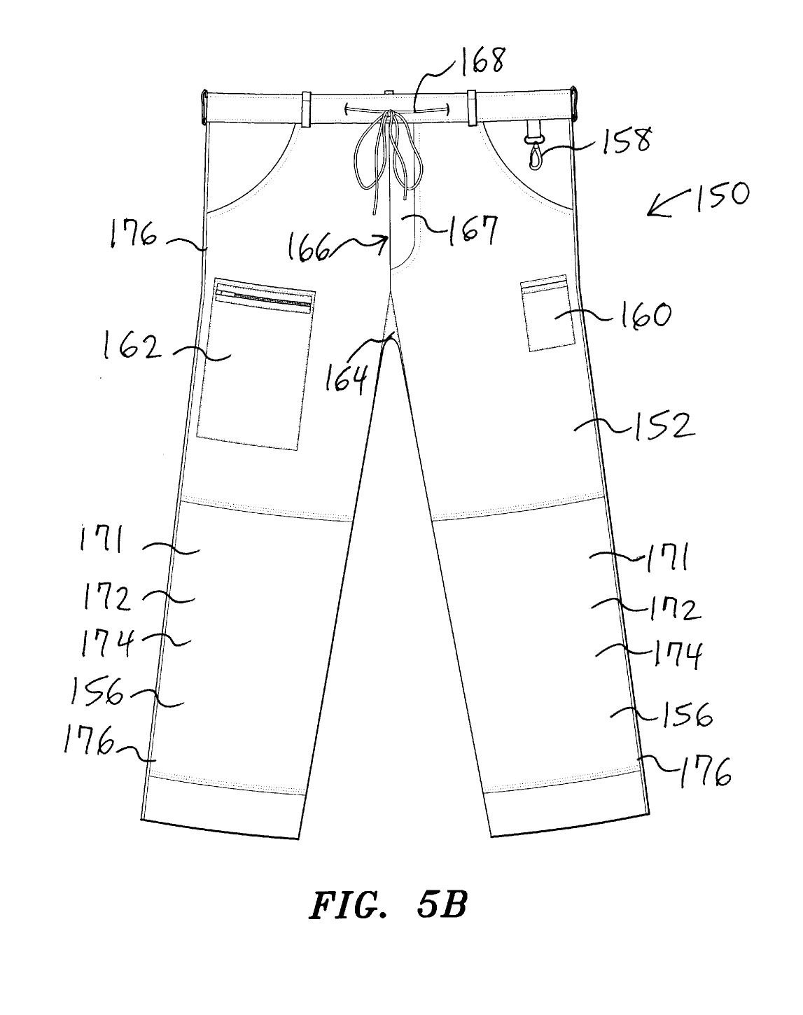

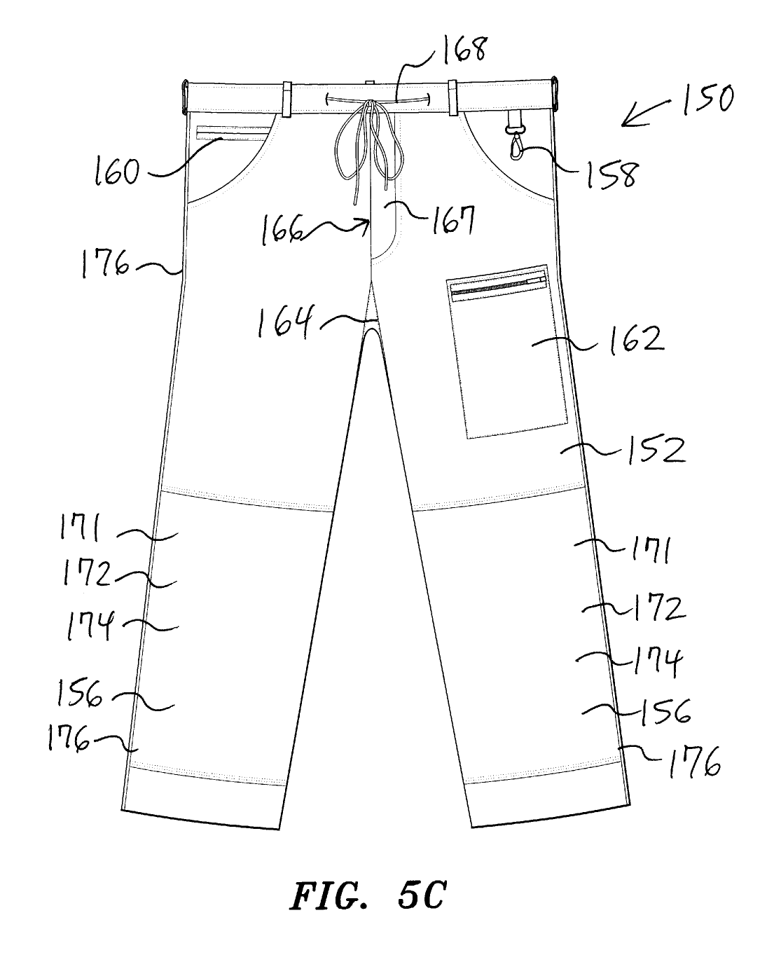

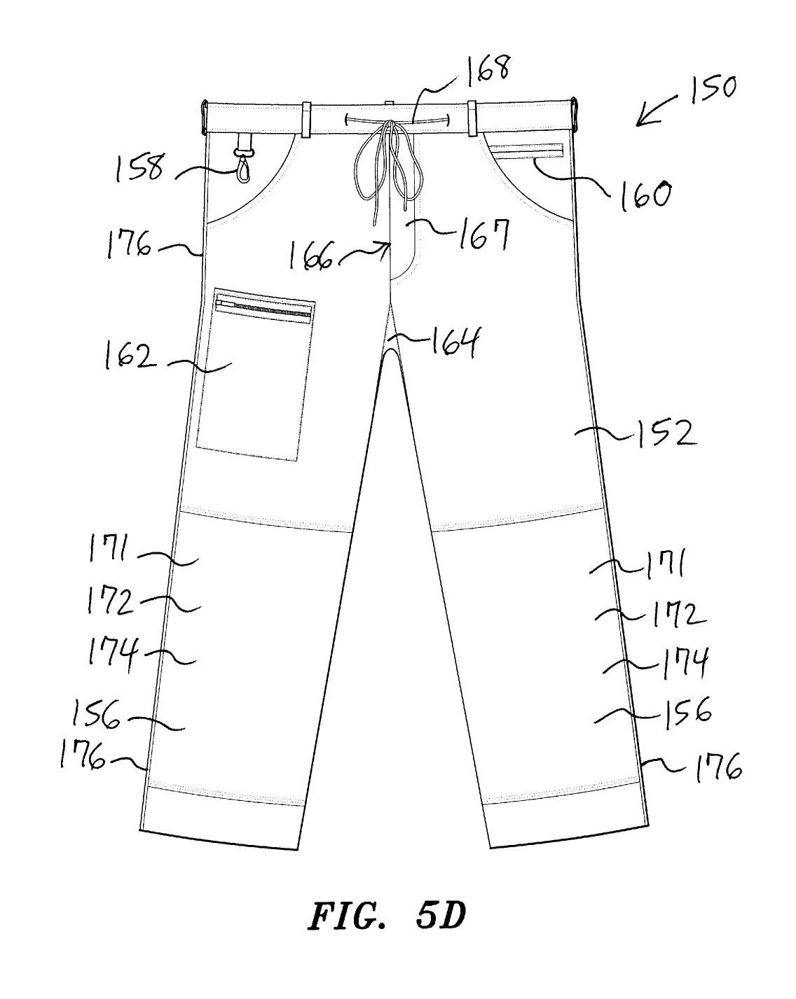

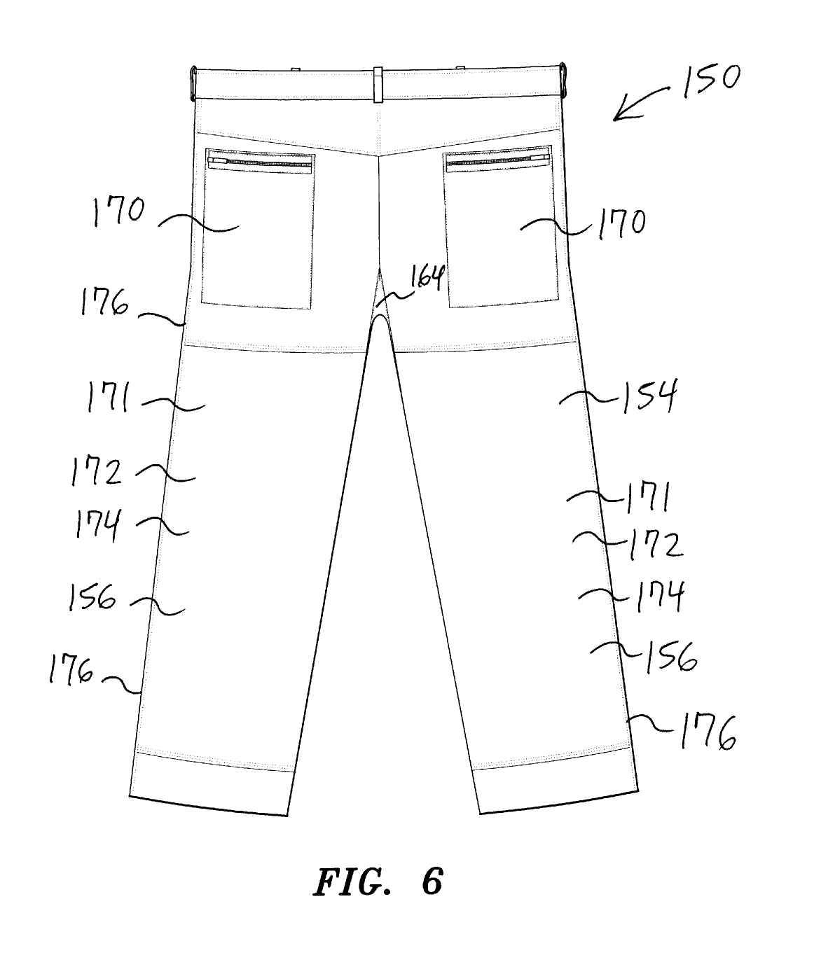

Referring to FIGS. 1-6, the present invention is directed to a garment or article of clothing 100 having antibacterial, antimicrobial, skin enhancement, skin regeneration, and/or skin wellness properties and utility functional compartments. The garment 100 may also have antifungal and antiyeast properties.

The garment 100 includes a top or shirt component 110 and a bottom or pant component 150. It is obvious to one of ordinary skill in the art that a user or wearer may wear both components 110,150 together, or either component 110,150 separately with other garments. The garment 100 may be worn as a uniform, scrub, etc. by medical professionals, other health care professionals, their staff workers, and any other individual requiring or desiring such a garment, in various environments, such as, but not limited to, hospitals, medical and health care offices, etc. Also, the garment 100 may be made or manufactured to custom fitting and styling for users of either gender and different age groups.

As a non-limiting example and as best shown in FIGS. 1-4B, the top component 110 has a front side 112, a rear side 114, right and left sleeves 116,118, a neck opening 120, an effective amount of an antimicrobial agent 122, an identification (I.D.) ring 124, a pen pocket 126, and a gusset 128,130 in each of the armpit areas. The top component 110 may also have at least one pocket 132 on the front side 112, at least one pocket on the rear side 114, and at least one sleeve pocket 134 at one or both of the sleeves 116,118. Further, the top component 110 may have an effective amount of an antibacterial agent 135, an effective amount of an antifungal agent 136, and/or an effective amount of an antiyeast agent 138.

The neck opening 120 of the top component 110 may have a V-shape, a regular or round shape, or any other shape known to one of ordinary skill in the art. The V-shape of the neck opening 120 may help to provide comfort to the wearer, especially to those involved in an activity of prolonged duration, such as an operating room medical professional or staff worker, or to those wearing the top component 110 for a prolonged period of time.

The antimicrobial agent 122 preferably provides the top component 110 with antibacterial, antimicrobial, antifungal, antiyeast, skin enhancement, skin regeneration, and/or skin wellness properties, and is preferably dispersed or positioned throughout, within, above or below the fabric 140 of the top component 110. The antimicrobial agent 122 may be a, or comprised of a, metal antimicrobial component, such as a copper component, such as, but not limited to, copper oxide, or any, or comprised of any, other metal antimicrobial component known to one of ordinary skill in the art. Preferably, the effective amount of copper component, such as copper oxide, is such that the panels of fabric contain in a range of about 20% to about 40% of copper component, and more preferably in a range of about 25% to about 40% of copper component. Also, the antimicrobial agent 122 may be any non-metal antibacterial, antimicrobial, antifungal, or antiyeast component or agent or combination of antibacterial, antimicrobial, antifungal, and antiyeast components or agents known to one of ordinary skill in the art wherein the non-metal component or agent or combination of components or agents provides some, many or all of the antibacterial, antimicrobial, antifungal, antiyeast, skin enhancement, skin regeneration, and/or skin wellness properties.

The identification (I.D.) ring 124 is for the attachment of an I.D. badge. Also, the I.D. ring 124 may be positioned at any predetermined location, such as, but not limited to, one side of the chest area, on the front side 112 of the top component 110. The identification (I.D.) ring 124 may be made of a copper metal and/or some other metal(s) that could provide additional antibacterial, antimicrobial, antifungal, antiyeast, skin wellness, skin enhancement, and/or skin regeneration properties.

The pen pocket 126 is for holding or retaining writing instrument(s), such as a pen, at the front side 112. Also, the pen pocket 126 may be positioned at any predetermined location, such as, but not limited to, the other side of the chest area, on the front side 112 of the top component 110. The pen pocket 126 may be an applicable slot pocket or pockets for one pen, two pens, or more than two pens.

The gusset 128,130 in each of the armpit areas helps to eliminate or reduce chaffing in the armpit areas. The gusset 128,130 may have the shape as shown in the drawings, or may have any shape known to one of ordinary skill in the art.

The pocket or pockets 132 at the front side 112 of the top component 110 is for storing or retaining business cards, money, coins, a cellular phone, and/or any other item that may fit within or in that pocket 132. The pocket 132 at the front side 112 of the top component 110 may be a zippered pocket or any pocket known to one of ordinary skill in the art.

The pocket or pockets at the rear side 114 of the top component 110 is for storing or retaining business cards, money, coins, a cellular phone, and/or any other item that may fit within or in that pocket. The pocket at the rear side 114 of the top component 110 is preferably the same as or substantially the same as the pocket 132 at the front side 112, and may be a zippered pocket or any pocket known to one of ordinary skill in the art.

The sleeve pocket 134 is for storing or retaining business cards, money, coins, a cellular phone, and/or any other item that may fit within or in that pocket 134. The sleeve pocket 134 may be a zippered and slot pocket or any pocket known to one of ordinary skill in the art.

Each of the agents 135,122,136,138 relating to antibacterial, antimicrobial, antifungal, and antiyeast properties, provides the top component 110 with corresponding antibacterial, antimicrobial, antifungal, and antiyeast properties, and is preferably dispersed or positioned throughout, within, above or below the fabric 140 of the top component 110. The antibacterial agent 135 may be any antibacterial agent or combination of antibacterial agents known to one of ordinary skill in the art. The antimicrobial agent 122 may be any antimicrobial agent or combination of antimicrobial agents known to one of ordinary skill in the art. The antifungal agent 136 may be any antifungal agent or combination of antifungal agents known to one of ordinary skill in the art. The antiyeast agent 138 may be any antiyeast agent or combination of antiyeast agents known to one of ordinary skill in the art. Preferably, the antimicrobial agent 122 plays the roles of agents relating to antibacterial, antimicrobial, antifungal, and antiyeast properties.

As a non-limiting example and as best shown in FIGS. 1, 2, 5A-5D and 6, the bottom or pant component 150 has a front side 152, a rear side 154, an effective amount of an antimicrobial agent 156, an identification (I.D.) and key ring 158, a cell phone pocket 160, a cargo pocket 162, a gusset 164 in the crotch area, a fly opening item 166, and a bottom component securing means 168. The bottom component 150 may also have at least one pocket 170 on the rear side 154. Further, the bottom component 150 may have an effective amount of an antibacterial agent 171, an effective amount of an antifungal agent 172, and/or an effective amount of an antiyeast agent 174.

The antimicrobial agent 156 preferably provides the bottom component 150 with antibacterial, antimicrobial, antifungal, antiyeast, skin enhancement, skin regeneration, and/or skin wellness properties, and is preferably dispersed or positioned throughout, within, above or below the fabric 176 of the bottom component 150. The antimicrobial agent 156 may be a, or comprised of a, metal antimicrobial component, such as a copper component, such as, but not limited to, copper oxide, or any, or comprised of any, other metal antimicrobial component known to one of ordinary skill in the art. Preferably, the effective amount of copper component, such as copper oxide, is such that the panels of fabric contain in a range of about 20% to about 40% of copper component, and more preferably in a range of about 20% to about 35% of copper component. Also, the antimicrobial agent 156 may be any non-metal antibacterial, antimicrobial, antifungal, or antiyeast component or agent or combination of antibacterial, antimicrobial, antifungal, and antiyeast components or agents known to one of ordinary skill in the art wherein the non-metal component or agent or combination of components or agents provides some, many or all of the antibacterial, antimicrobial, antifungal, antiyeast, skin enhancement, skin regeneration, and/or skin wellness properties. Preferably, the antimicrobial agent 156 of the bottom component 150 is the same or substantially the same as the antimicrobial agent 122 of the top component 110.

The identification (I.D.) and key ring 158 may be made of a copper metal and/or some other metal(s) that could provide additional antibacterial, antimicrobial, antifungal, antiyeast, skin wellness, skin enhancement, and/or skin regeneration properties. The I.D. and key ring 158 is for the attachment of an I.D. badge and/or keys. Also, the I.D. and key ring 158 may be positioned at any predetermined location, such as, but not limited to, about the waist area of one side of the lower body area, on the front side 152 of the bottom component 150.

The cell phone pocket 160 is for holding or retaining a cellular phone at the front side 152. Also, the cell phone pocket 160 may be positioned at any predetermined location, such as, but not limited to, a first thigh area or a first side about the waist area, on the front side 152 of the bottom component 150. The cell phone pocket 160 may be a slot pocket or any pocket known to one of ordinary skill in the art.

The cargo pocket 162 is for holding or retaining business cards, a wallet, money, coins, a cellular phone, and/or any other item that may fit within or in that pocket 162, and preferably has a depth that allows the cargo pocket 162 to hold or retain sheets of paper. Also, the cargo pocket 162 may be positioned at any predetermined location, such as, but not limited to, a second thigh area, on the front side 152 of the bottom component 150. The cargo pocket 162 may be a zippered pocket or any pocket known to one of ordinary skill in the art.

The gusset 164 in the crotch area helps to eliminate or reduce chaffing in the crotch area. The gusset 164 may have the shape as shown in the drawings, or may have any shape known to one of ordinary skill in the art. The gusset 164 of the bottom component 150 may be the same or substantially the same as the gussets 128,130 of the top component 110.

The fly opening item 166 is positioned about the crotch area on the front side 152 of the bottom component 150. The fly opening item 166 is preferably closed by a zipper, but may be closed by buttons or any other means known to one of ordinary skill in the art, and covered by a flap 167.

The bottom component securing means 168 allows the wearer to secure the bottom component 150 to the wearer's lower body. Preferably, the bottom component securing means 168 is a drawstring and/or belt loops for receiving a belt. The bottom component securing means 168 may be any other bottom component securing means known to one of ordinary skill in the art.

The pocket 170, or each of the pockets 170, on the rear side 154 of the bottom component 150 is for storing or retaining business cards, money, coins, a cellular phone, and/or any other item that may fit within or in that pocket 170, and preferably has a depth that allows the pocket 170 to hold or retain sheets of paper. The pocket 170 on the rear side 154 of the bottom component 150 may be a zippered pocket or any pocket known to one of ordinary skill in the art.

Each of the agents 171,156,172,174 relating to antibacterial, antimicrobial, antifungal, and antiyeast properties, provides the bottom component 150 with corresponding antibacterial, antimicrobial, antifungal, and antiyeast properties, and is preferably dispersed or positioned throughout, within, above or below the fabric 176 of the bottom component 150. The antibacterial agent 171 may be any antibacterial agent or combination of antibacterial agents known to one of ordinary skill in the art. The antimicrobial agent 156 may be any antimicrobial agent or combination of antimicrobial agents known to one of ordinary skill in the art. The antifungal agent 172 may be any antifungal agent or combination of antifungal agents known to one of ordinary skill in the art. The antiyeast agent 174 may be any antiyeast agent or combination of antiyeast agents known to one of ordinary skill in the art. Preferably, the antimicrobial agent 156 plays the roles of agents relating to antibacterial, antimicrobial, antifungal, and antiyeast properties. Preferably, the agents 156,171,172,174 of the bottom component 150 are the same or substantially the same as the agents 122,135,136,138 of the top component 110.

The fabrics 140,176 of the top and bottom components 110,150 may be any natural, man-made, or a combination of natural and man-made fabric known to one of ordinary skill in the art. The fabrics 140,176 may be comprised of fibers, such as natural (for example, cotton, silk, wool, and linen) or synthetic yarns spun from those fibers, and woven, knit, and non-woven fabrics made of those yarns. The scope of the invention includes all natural fibers; and all synthetic fibers used in textile applications, including but not limited to synthetic cellulosic fibers (i.e., regenerated cellulose fibers such as rayon, and cellulose derivative fibers such as acetate fibers), regenerated protein fibers, acrylic fibers, polyolefin fibers, polyurethane fibers, and vinyl fibers, but excluding nylon and polyester fibers, and blends thereof. Preferably, the fabrics 140,176 of the top and bottom components 110,150 are the same or substantially the same as one another. The present invention may also include copper metal and/or some other metal components that provide antibacterial, antimicrobial, antifungal, antiyeast, skin enhancement, skin wellness, and/or skin regeneration properties.

It is to be understood that the present invention is not limited to the embodiments described above or as shown in the attached figures, but encompasses any and all embodiments within the spirit of the invention.

What is claimed is:

1. An article of clothing having at least one property selected from the group consisting of antibacterial, antimicrobial, antifungal, and antiyeast properties, said article of clothing comprising:
a fabric comprising an effective amount of copper component in a range from about 20% to about 40%.

2. The article of clothing according to claim 1, wherein said range is from about 20% to about 35%.

3. The article of clothing according to claim 1, wherein said copper component is copper oxide.

4. The article of clothing according to claim 1, wherein said article of clothing has at least one property selected from the group consisting of skin enhancement, skin regeneration, and skin wellness properties.

5. An article of clothing having at least one property selected from the group consisting of antibacterial, antimicrobial, antifungal, and antiyeast properties, said article of clothing comprising:
at least one clothing component selected from the group consisting of a top component and a bottom component, wherein said at least one clothing component comprises a fabric comprising an effective amount of copper component in a range from about 20% to about 40%.

6. The article of clothing according to claim 5, wherein said range is from about 20% to about 35%.

7. The article of clothing according to claim 5, wherein said copper component is copper oxide.

8. The article of clothing according to claim 5, wherein said article of clothing has at least one property selected from the group consisting of skin enhancement, skin regeneration, and skin wellness properties.

9. The article of clothing according to claim 5, wherein said article of clothing comprises a top component and a bottom component.

10. The article of clothing according to claim 9, wherein said range is from about 20% to about 35%.

11. The article of clothing according to claim 9, wherein said copper component is copper oxide.

12. The article of clothing according to claim 9, wherein said article of clothing has at least one property selected from the group consisting of skin enhancement, skin regeneration, and skin wellness properties.
